(19) United States
(12) Patent Application Publication
(10) Pub. No.: US 2011/0194920 A1
(43) Pub. Date: Aug. 11, 2011

(54) Jezco container inside a jezco waste collection truck

(76) Inventor: Thomas Gesuale, Northport, NY (US)

(21) Appl. No.: 12/653,210

(22) Filed: Feb. 5, 2010

(51) Int. Cl. B60P 1/00

(52) U.S. Cl. 414/467

(57) ABSTRACT

The Jezco Waste Collection Truck provides a completely new method of picking up garbage on the residential and commercial garbage route. Instead of the garbage going into a vehicle that has to be dumped at an intermediate location then reloaded, the garbage goes into a leak proof container which is not dumped till the garbage reaches it final destination. The Jezco Waste Collection Truck is a medium duty 2 axle truck that holds the patented Jezco Container. This truck is a lighter duty vehicle than the standard garbage truck which is typically a 3 axle unit and much heavier. As a result the Jezco Waste Collection Truck is a less expensive unit. The Jezco Container is 100 percent leak proof and will not spill garbage juices onto the roadways and will eliminate the transmission of rodents. The Jezco Container has the ability to access back haul trucking which will reduce the fuel consumption used in hauling garbage and reduce the number of trucks on the road for garbage hauling.

This specification outlines a unique and innovative municipal waste collection unit. The name of the unit is the “Jezco Waste Collection Truck”. This patent application is being made by Mr. Thomas Gesuale, a citizen of the United States of America, residing at 11 Lady Jane's Way, Northport, N.Y. 11768. Mr. Gesuale has over 60 years experience in the waste and bulk materials hauling and waste management businesses and from this extensive experience and knowledge has developed the Jezco Waste Collection Truck. The Jezco Waste Collection Truck consists of a standard two axle, medium duty, tractor truck, the truck will be fitted with the Jezco designed truck body, and this unit will be used to carry the patented Jezco Container (U.S. Pat. No. 5,281,073). The Jezco Waste Collection Truck is designed to load the Jezco Container with municipal waste picked up on a typical city garbage route. The advantage of the Jezco Waste Collection Truck is that after the garbage is loaded into the Jezco Container, that garbage is never dumped again until it reaches its final disposal destination—a landfill or other final disposal site. This method of handling municipal waste collection eliminates the need for dumping garbage at a “transfer station” then reloading the garbage to take it to a landfill—the Jezco Collection Truck eliminates the solid waste transfer station and the ills and costs that go along with it.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCES

Not Applicable

### BACKGROUND

The status quo in municipal solid waste collection is the residential route “garbage truck”. Typically service is twice per week in most urban areas. We all put our garbage out by the roadside and our friendly garbage men do the critical job of coming and taking our garbage away.

Garbage after being picked up can be taken to a couple of different types of waste handling locations. It can be taken to a final disposal location—generally a landfill, where it is dumped and buried and that is the end of the disposal cycle.

In today's larger metropolitan areas, many don't have a landfill disposal repository. In these cases the garbage is taken to what is termed a “transfer station”. A waste transfer station is an intermediate dumping location where smaller trucks will dump their garbage so that the garbage can be consolidated into larger trucks and efficiently long hauled to a final disposal repository, i.e., again a landfill. The transfer station is typically a large building, so as to control odors and fugitive emissions, where trucks can go inside and dump the collected garbage. Then larger trucks are brought into the transfer station building and the garbage is re-loaded on to these larger transfer tractor trailer trucks. The transfer trailer trucks will then haul the garbage to the remote landfill location for final disposal of the wastes. The typical transfer station will receive anywhere from 100 (very small) to 2,000 (large) tons per day of garbage.

In the transfer station scenario to serve the waste management needs of a large metro area, this will involve dumping a lot of garbage into a building. The cost of labor and equipment to reload the garbage into larger long haul vehicles is expensive. And moreover there will also be odors and rodents associated with garbage handling at the transfer station and significant truck traffic in the community where the transfer station is located.

The regulatory requirements of siting a transfer station are difficult and costly to surmount. The permitting and permitting cost of the transfer station including engineering, permit preparations and applications, acquisition of public approvals, etc. represent a costly and long time cycle just to get approval to build any new transfer station. After the transfer station is built and operational there are ongoing regulatory costs and operations cost. No one really wants a garbage transfer station in their community due to the issues that go along with it so unfortunately this results in the transfer station being sited in lower economic communities that have the least ability to resist the siting—but the need for transfer stations to manage the waste collection makes it, at best, a necessary evil.

### BRIEF SUMMARY OF THE INVENTION

The Jezco Waste Collection Truck uses an innovative process to collect residential waste that results in the elimination for the need of a garbage transfer station. This represents a very significant improvement in environmental and health impacts to the community. Additionally, elimination of the transfer station reduces the cost of municipal waste collection and disposal.

With the Jezco Waste Collection Truck the garbage is pick up on the route exactly as it is done with the conventional garbage truck. Along the collection route waste is accumulated into the patented Jezco Container (U.S. Pat. No. 5,281,073). The Jezco Container is a 100 percent leak-proof solid steel container which has been used in waste hauling applications for many years. After the container is filled the Jezco Waste Collection Truck takes the filled container to a central storage location. The filled container is removed from the Jezco Collection Truck and covered. The filled containers are collected at the centralized storage location. These filled containers will finally be transloaded on to long haul tractor trailer trucks and taken to a landfill. At the landfill the containers are finally dumped.

The advantage of the Jezco Truck and Jezco Container is that the garbage is never dumped at any location until it reaches its final disposal location—the landfill. This avoids the labor and equipment cost for reloading massive amount of garbage on to long haul dump trucks. Not dumping the garbage also eliminates the regulatory and permitting issues associated to a garbage transfer station. And additionally, not dumping the garbage at a transfer station avoids transferring the debris, odors, and rodents that are ubiquitous in garbage handling at a transfer station.

The use of the Jezco Waste Collection Truck and Jezco Container will save money in the processes of waste collection, handling, and hauling. The Jezco Waste Collection Truck is a 2 axle truck and not as heavy duty as the standard garbage collection truck (generally a 3 axle vehicle) since the Jezco Waste Collection Truck never needs to go into a landfill. The Jezco Collection Truck results in a 20 percent cost saving per unit versus the status quo collection vehicle. In the handling, since the garbage is not dumped it doesn't require the expensive equipment to reload the garbage into tractor trailer dump trucks. Finally since the Jezco Containers are carried with a flatbed or van trailer, these units are more available on the roads with back haul pricing.

### BRIEF DESCRIPTION OF THE DRAWINGS AND FIGURES

### List of Figures

### Certain of the Figures Listed Below are Represented by Color Photographs as Indicated

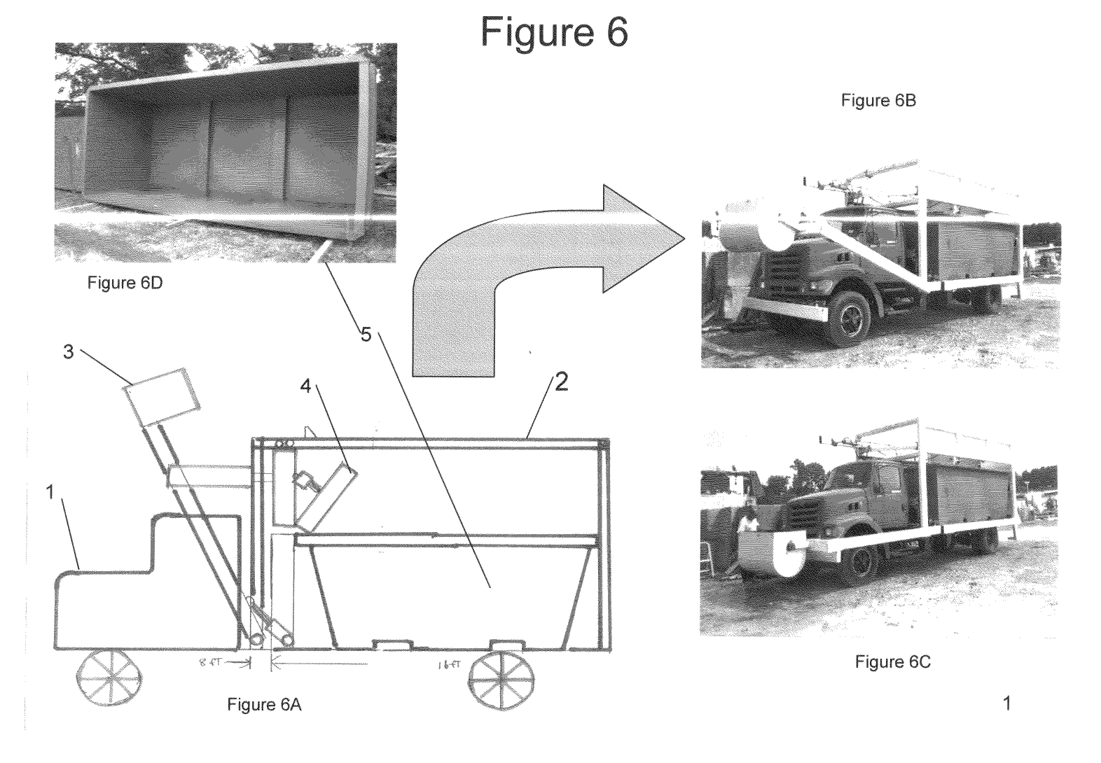

FIG. 6—Overview Jezco Waste Collection Truck (drawing and photograph)
Item 1: Tractor Truck
2-axle, medium duty tractor truck, used to pickup municipal garbage routes. Advantage of this truck over standard garbage truck is it can be lighter duty as it operates over short routes and never goes to a landfill. This type truck unit is less expensive and more fuel efficient.
Item 2: Jezco Truck Body
Heavy steel frame body design, customized for accepting and securing Jezco Container and mounting of the Waste Compactor Assembly.
Item 3: Front Waste Bucket Loader
Collected garbage is loaded into the bucket. The bucket is hydraulically tipped over the top of the truck and discharged into the Jezco Container. The bucket loader can also be rear mounted.
Item 4: Waste Compactor Assembly
Compactor operates hydraulically traveling from front to rear repeatedly, and applying force vertically down to compact the loose waste, maximizing the loading of the Jezco Container.
Item 5: Jezco Container
The proprietary Jezco Container (U.S. Pat. No. 5,281,073) is inserted and withdrawn from the truck using a folk lift. The container is designed to carry 8 tons of compacted municipal waste. The container is totally “leak-proof” and will not spill or leak waste liquids along the pickup route.

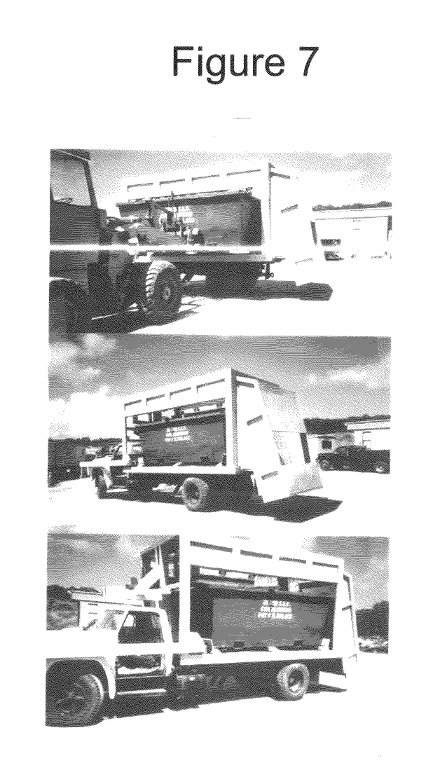

FIG. 7—Jezco Container Inserted Into Jezco Truck Body (photograph)

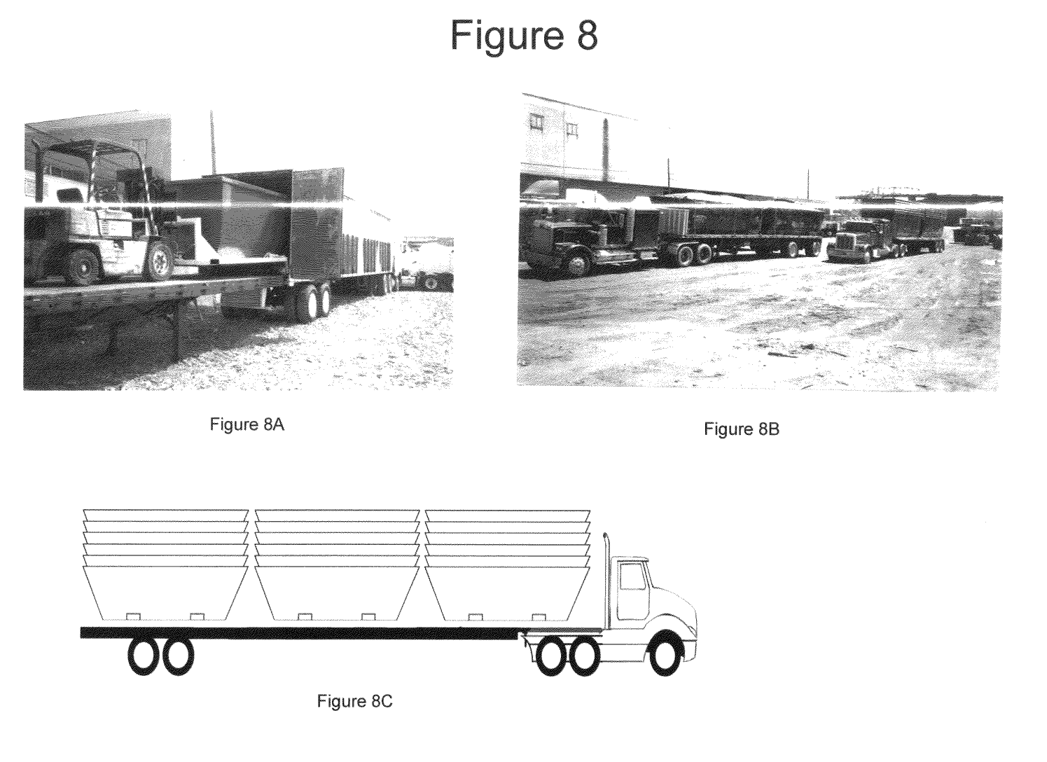

FIG. 8—Jezco Container Carrying—Van Trucks and Flatbed Trucks (drawing and photographs)

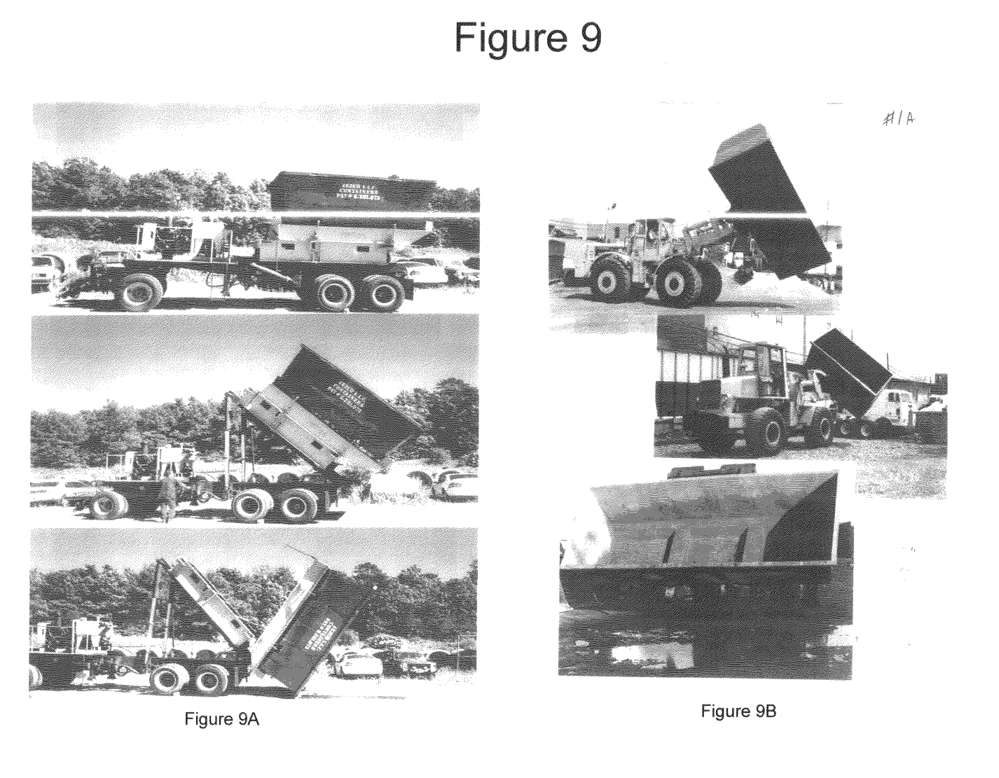

FIG. 9—Jezco Container Dumping Mechanisms (photograph)

### DETAILED DESCRIPTION OF THE INVENTION

### Description of Equipment

FIG. 6 provides a breakdown of the equipment for the Jezco Waste Collection Truck. Referring to FIG. 6, item 1 is a standard 2 axle, medium duty, tractor truck. Item 2 in the figure is the proprietary Jezco truck body frame that is designed to carry the patented Jezco Container, Item 5. The Jezco Container is a leak-proof container suited to carry bulk freight including solid waste, liquid wastes, sludge, contaminated soils, and ash. The Jezco Container has a capacity of 8 tons or 18 cubic-yards, and is 15 feet long. Item 3 is the waste bucket used to hydraulically lift the waste picked up on the collection route to be discharged into the Jezco Container. Item 4 is a hydraulic compactor which compresses the waste into the Jezco Container to maximize container space utilization. Pictured as FIGS. 6B and 6C is a prototype of the fully configured Jezco Waste Collection Truck and of the Jezco Container.

### Waste Collection Truck Operation

FIG. 7 provides a photographic depiction of the Jezco Waste Collection Truck. The tractor truck, is a 2 axle medium duty truck which would be less expensive and more fuel efficient than the conventional heavy duty garbage route truck. The conventional garbage route trucks are designed to go into a landfill and dump their collected waste. Since the Jezco truck returns loaded containers to a central collection location, the Jezco Truck does not have to have the duty capability for going into a landfill. The trucks of a waste collection operator represent a significant component of the capital investment for the business. With the Jezco truck being lighter duty and more fuel efficient, this is a competitive advantage cost saving for the waste collection operator. FIG. 7 depicts the container being inserted to the Jezco Truck Body which is designed to be mounted on the truck. The truck body is a steel frame structure and customized for accepting and securing the Jezco Container. Additionally the truck body provides the mountings for the compactor assembly, FIG. 6 Item 4. As loose garbage is discharged into the Jezco Container using the bucket loader (Item 3), the compactor assembly compacts the loose garbage to maximize the weight into the container.

### Jezco Waste Collection Operation

The waste collection operation using the Jezco Waste Collection Truck starts with the Jezco Container being inserted into the truck body using a standard folk lift. The Jezco Waste Collection Truck with the container will travel the garbage collection route and the garbage is picked up and dumped into the bucket loader then the bucket loader hydraulically discharges over the cab and top of the truck and into the Jezco Container. As the loose trash is discharged into the container, the compactor assembly is hydraulically actuated and travels from front to rear with and applying vertical downward pressure to compact the waste and maximize the loading of the container. Each container is designed to be loaded to approximately 8 tons of garbage.

After the container is filled, the loaded container is returned to a centralized collection location—a “Drop Station”, where the filled container is removed from the truck and another empty container is placed inside the truck. The truck would then proceed to make another collection route run. For a typical day the truck would make 3 collection runs to pickup 24 tons of garbage per day.

The Jezco Containers are not dumped at the Drop Station. The containers are covered and since the containers are 100 percent leak-proof nothing which has been collected in the container can get out. The Jezco Container is designed to carry municipal solid waste, liquid waste, sludge, and ash and unlike the standard trucks that leak garbage “juices” on the streets, the Jezco Container is totally sealed and can not leak.

The Drop Station is the central collection point to consolidate and hold the filled containers temporarily. The filled containers would ultimately be transloaded on to a long haul tractor trailer flat-bed or van truck. Three containers are loaded on the tractor trailer and delivered to a final waste disposal location, generally a landfill. Since the containers are never dumped until they get to the landfill there is no need for a transfer station that would require the reloading of loose garbage into long haul dump trucks. This eliminates the cost of reloading and the equipment, debris, eye soar, and rodent transmission associated with the transfer station.

The Jezco Container (FIG. 6D photographic view) holds U.S. Pat. No. 5,281,073 and has been used in solid waste hauling for many years by the major waste management companies in the U.S. including being licensed to Waste Management, Inc., the largest waste management company in the U.S. FIG. 8 depicts the Jezco Container loaded onto either flat-bed trucks or van tractor trailers for carrying the loaded containers to the landfill. After dumping the containers at the landfill, the empted containers accumulated at the landfill are returned up to 27 at a time on 1 return load. FIG. 9 depicts methods to dump the Jezco Container at the landfill.

### Benefits and Potential

The most significant benefit of the Jezco Waste Collection Truck used along with the Jezco Container is the elimination of the garbage Transfer Station. This has prodigious benefits to the community that would otherwise be served for waste management collection by a Transfer Station. The eye-soar, debris, and rodent infestation are all elements of the Transfer Station that are eliminated using the Jezco Waste Collection Truck.

The Jezco Container is 100 percent leak proof and cannot leak liquids that are typical to the standard waste collection truck. If anyone has had to drive behind a waste collection truck you know the odor is pungent and you can see the liquids leaking from the truck. These liquids are generally referred to as “garbage juices”. The Jezco Container is suitable for all types of wastes: solid waste, liquid waste, food waste, waste sludge, ash, and special wastes and will not leak the material anywhere along the road ways and highways.

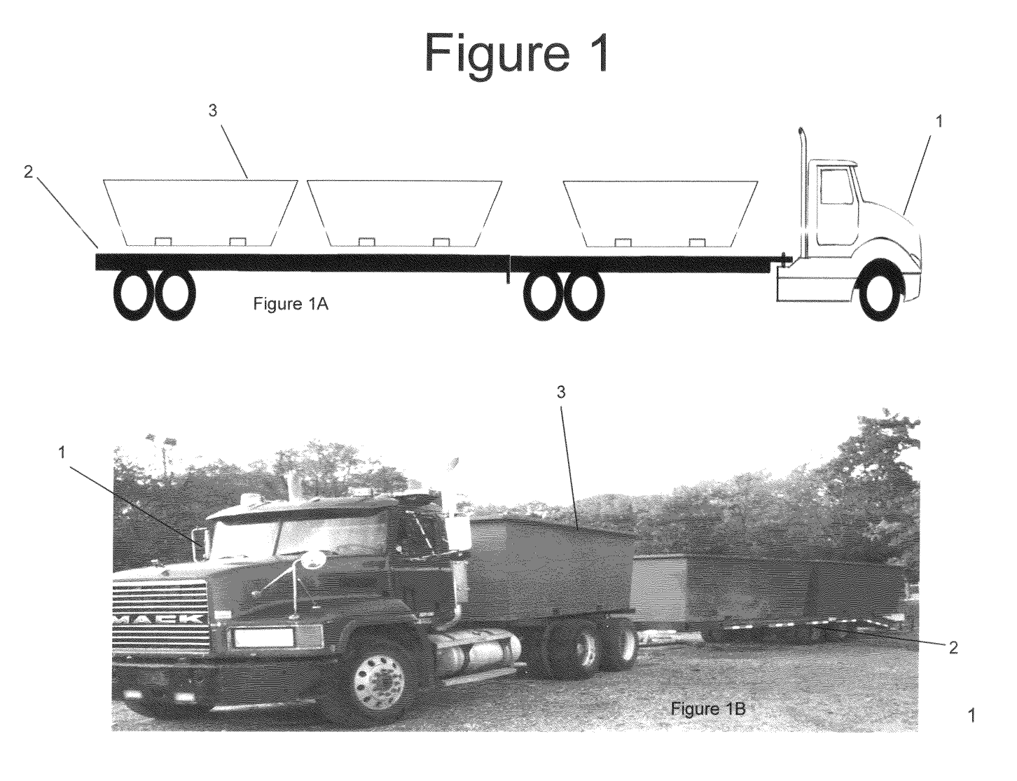

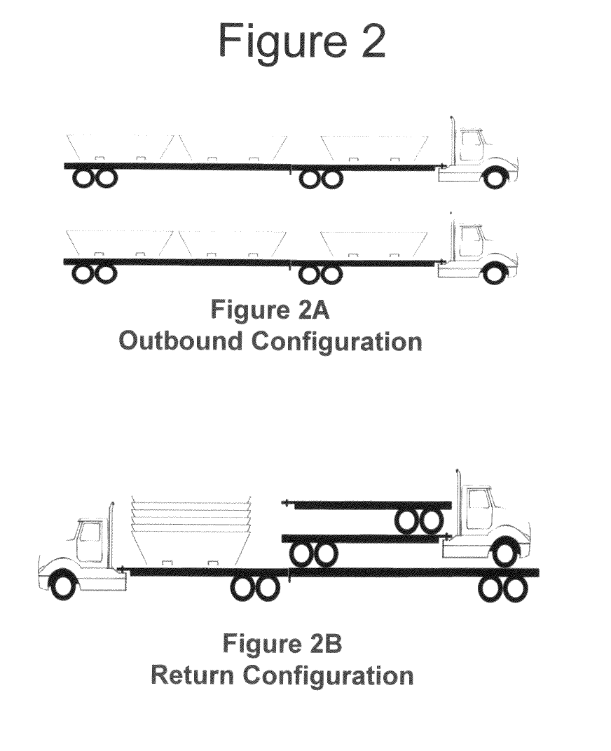

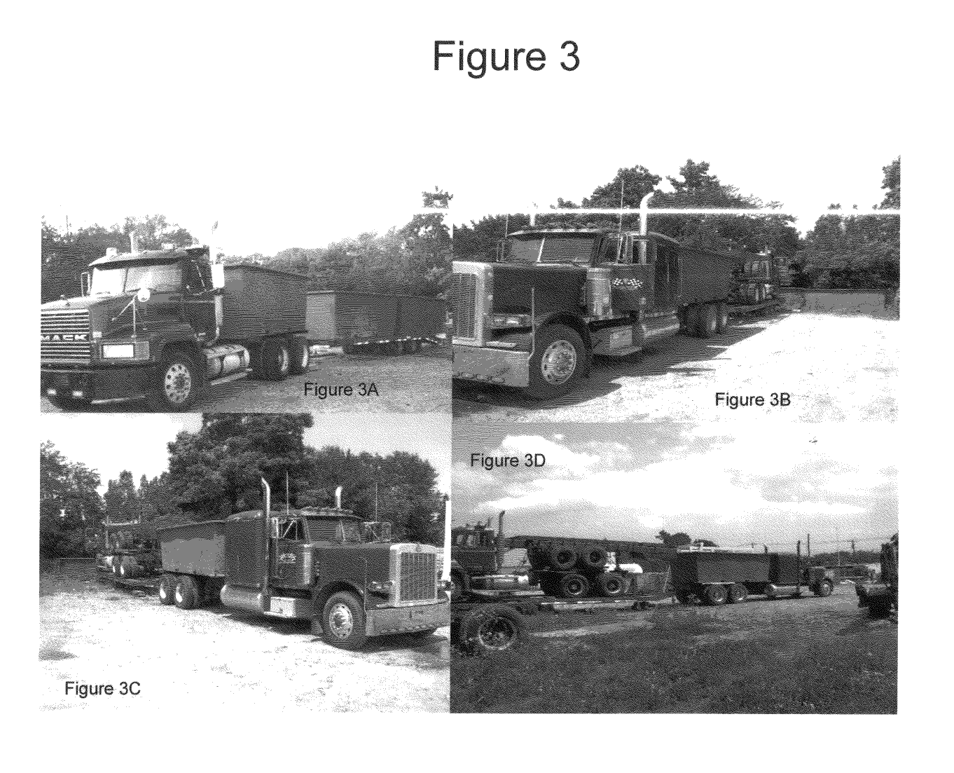

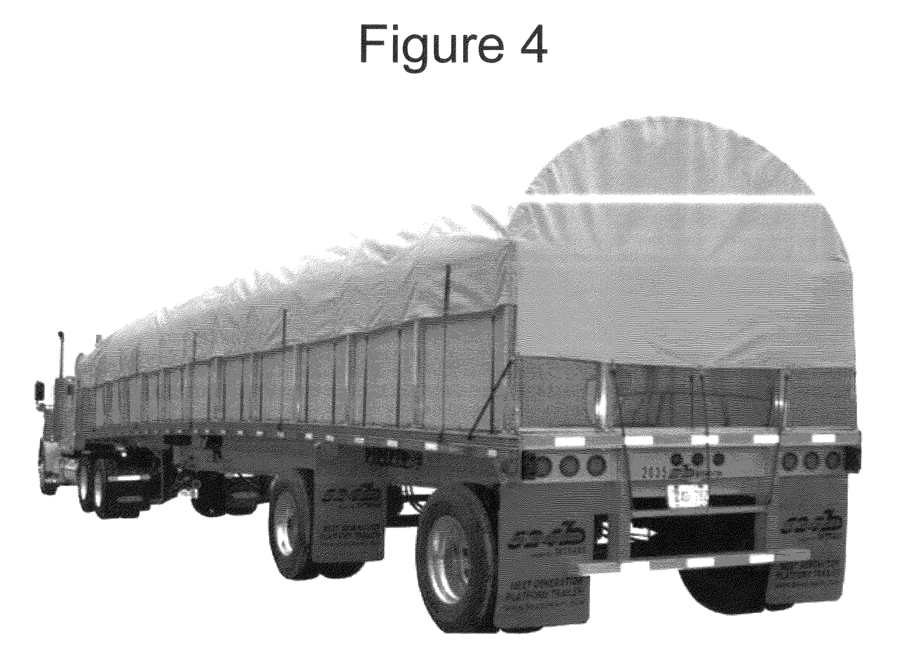

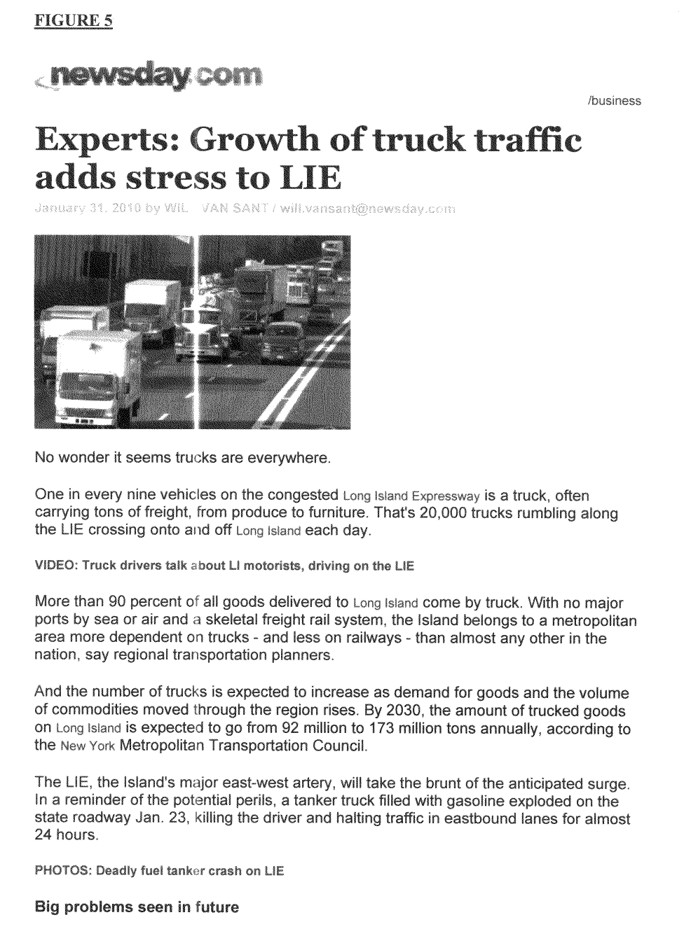

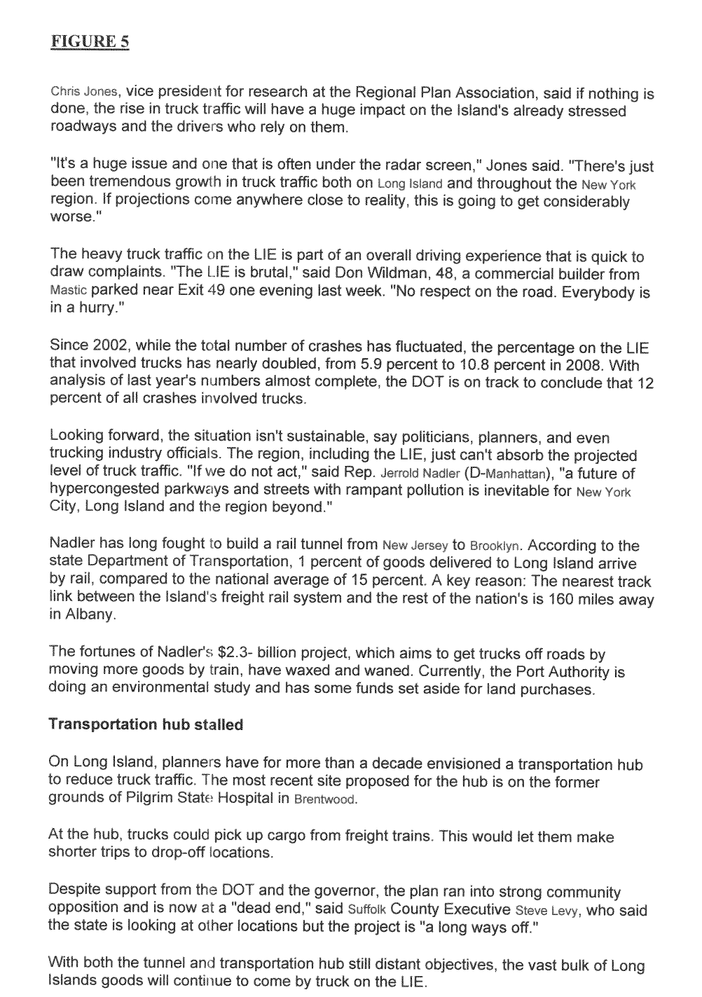

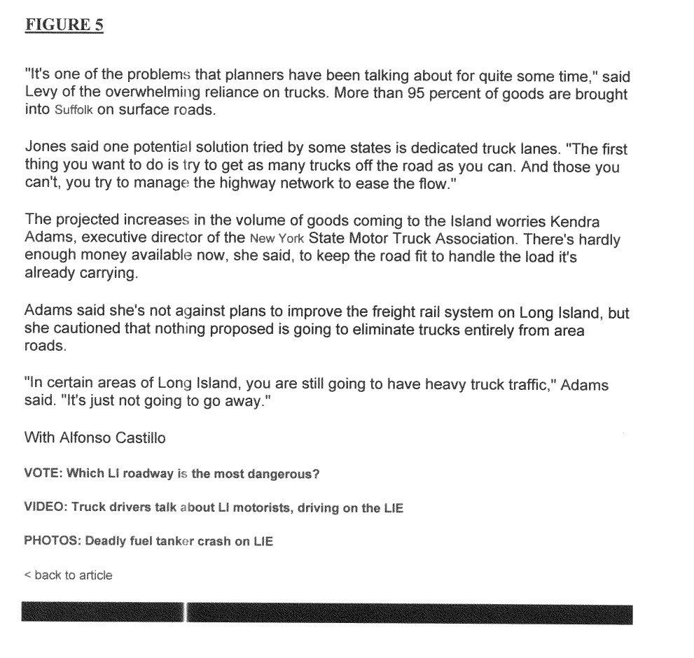

A means to reduce the number of heavy trucks on the highways is becoming more and more critical in many communities—refer to article, FIG. 5 for Long Island, N.Y. The Jezco Waste Collection Truck and Jezco Container will reduce the number of tractor truck vehicles on the highways by diversification of the hauling modes. As depicted in FIG. 8 the Jezco Container can be transloaded on to flat-bed tractor trailer trucks, van tractor trailers, and can use the inter-modal system. The potential for traffic reduction will depend on the specific region and the amount and type of freight traffic already in the region. However, due to the ability of the Jezco Container to take advantage of flat-bed and van tractor trailer trucks, any community will have some amount back haul traffic that can be accessed that will reduce the number of tractor trailer trucks on the highways which will correlate to fewer tractor truck accidents, will result in cost savings by accessing available back haul loads, and will reduce the number of vehicles on the roads and reducing traffic congestion.

The Jezco Waste Collection Truck will promote environmental sustainability. With fewer tractor trailer trucks needed to handle transport of the garbage to the landfill this will save fuel and eliminate the emissions associated with that fuel consumption.

### Economic Example

For illustrative purposes we can use a major metro area like New York City. New York City generates approximate 11,000 tons per day of municipal waste in the five boroughs of Queens, Staten Island, Manhattan, Brooklyn, and the Bronx. This waste is collected in typical rear load garbage trucks off the roadsides and delivered to and dumped at various transfer stations within the boroughs. At the transfer stations the garbage is reloaded into long haul walking-floor or dump tractor trailers (some of NY City's garbage is also handled by railroad) and then hauled over the roadways and highways to remote landfills approximately 500 miles away.

Each tractor trailer carries approximately 22 tons of garbage. Therefore if NY City was to handle all its garbage with long haul walking floor tractor trailers this would require 500 trucks per day to be loaded and to make a round trip of 1,000 miles per truck per day. The fuel efficiency of the typical tractor truck is approximately 5 miles per gallon, so to make the 1,000 mile round trip consumes 200 gallons of diesel fuel. For 500 trucks per day to make this round trip consumes 100,000 gallons of fuel per day or 26 million gallons per year. Using a diesel price of $3.00 per gallon results in fuel cost of $300,000 per day or approximately $78 million per year in fuel cost. The Jezco Container System is able to take advantage of back haul traffic already returning westward and southward from NY City. Thousands of flat-bed and van trucks are available leaving NY City and Long Island and are available to for a back haul. Assuming we use back haul traffic to deliver the loaded Jezco Containers from Drop Stations in NY City and to the same landfills, after dropping the containers at the landfill the trucks would not need to return. (Except for every nine loads of waste delivered to the landfills, one load would need to return to bring back the empty containers, 1 truck can return up to 27 empty nested containers.) With this scenario, leaving NY City loaded with waste would be 500 trucks per day making back hauls, and returning to bring back the empty containers would be approximately 60 trucks per day. The fuel consumption for this scenario would be 56,000 gallons per day or 14.6 million gallons per year. Again with diesel at $3.00 per gallon this represents $168,000 per day or $43.7 million per year in fuel cost.

From the above scenario using the Jezco Container to its full potential results in a fuel savings of approximately $34.3 million per year—every year! But the savings using the Jezco Waste Collection Truck are even more when considering the equipment savings which result from lighter duty equipment which is initially less costly and less expensive to operate and maintain. Also the savings are from elimination all-together of the transfer station operations. The savings in using the Jezco Waste Collection Truck System and Jezco Container in a metro area like NY City could potentially reach $100 million per year—every year! For each 100 gallons of diesel fuel saved this is equivalent to 10 barrels of crude oil or in the scenario examined this represents the equivalent of 1,140,000 barrels of crude oil per year—every year!

1 Using the Jezco Waste Collection Truck and Jezco Container for municipal garbage collection will eliminate the garbage Transfer Station in the community. The Jezco system will use a local Drop Station to collect the filled containers and the containers are transloaded on to hauling vehicles for delivery to the landfill. The garbage is not dumped and then reloaded.
Using the Jezco Waste Collection Truck and Jezco Container will save money in the process of municipal waste collection and disposal. Savings result from reduced capital investment in waste collection and handling vehicles and equipment, saving in fuel by taking advantage of back haul traffic, savings from the elimination of the transfer station operations, and savings in regulatory and permitting costs.
Using the Jezco Waste Collection Truck and Jezco Container will promote environmental sustainability by reducing the fuel consumption requirements for municipal waste collection and disposal and thus eliminating the associated greenhouse gas emissions.
Using the Jezco Waste Collection Truck and Jezco Container will promote health and safety. The Jezco Containers are 100 percent leak proof. Garbage juices cannot be spilled out onto the roadways. Additionally, since the Jezco Container is not dumped at a transfer station, this eliminates the transmission of rodents from one community to another.
Using the Jezco Waste Collection Truck and Jezco Container will reduce the number of tractor trailer trucks needed for long hauling of municipal waste and this will correlate to increased highway road safety and correlates to fewer highway accidents and improved traffic flow.
